(19) United States
(12) Patent Application Publication
(10) Pub. No.: US 2026/0222682 A1
(43) Pub. Date: Jul. 30, 2026

(54) FOCUSING APPARATUS, IMAGE PICKUP APPARATUS, FOCUSING METHOD, AND STORAGE MEDIUM

(71) Applicant: CANON KABUSHIKI KAISHA, Tokyo (JP)

(72) Inventor: NOA SUMIDA, Chiba (JP)

(21) Appl. No.: 19/419,610

(22) Filed: Dec. 15, 2025

(30) Foreign Application Priority Data
Jan. 29, 2025 (JP) 2025-012845

(51) Int. Cl. H04N 23/67; G02B 27/01; G03B 13/36; H04N 13/106; H04N 23/611

(52) U.S. Cl. CPC H04N 23/675; G02B 27/0101; G03B 13/36; H04N 13/106; H04N 23/611; H04N 23/672; G02B 2027/0134; G02B 2027/0138; G02B 2027/014

(57) ABSTRACT

A focusing apparatus includes one or more memories storing instructions, and one or more processors that, upon execution of the instructions, operate to set a first region used for focus detection in a first image formed via a first optical system and a second region used for focus detection in a second image formed via a second optical system, perform focusing by moving a lens included in at least one of the first and second optical systems, acquire, in a case where a difference between a first defocus amount of the first region and a second defocus amount of the second region is smaller than a first threshold value, a moving amount of the lens based on at least one of the first and second defocus amounts, and change sizes of the first and second regions in a case where the difference is greater than the first threshold value.

### BACKGROUND

### Field of the Technology

The aspect of the disclosure relates to one or more embodiments of a focusing apparatus, an image pickup apparatus, a focusing method, and a storage medium.

### Description of the Related Art

Some conventional twin-lens Virtual Reality (VR) cameras use two optical systems to capture two images with parallax in a single shot. Since the view angles differ between the two images due to parallax, the position of the object relative to each view angle shifts in the parallax direction. Furthermore, when the parallax is large, the view (angle) of the object also changes, and object information within the focus detecting region is different between the left and right images.

Japanese Patent Application Laid-Open No. 2024-052502 discloses a configuration that determining a focus detecting region of one image based on a focus detecting region set in the other image, a parallax amount, a distance between the optical axes, the optical axis shift between the attached lenses, or feature point matching, in order to correct a shift in a focus detecting region due to parallax.

Japanese Patent Application Laid-Open No. 2013-218049 discloses a configuration that arranges focus detecting regions of different sizes in a hierarchical structure and reduces their size while determining the in-focus level in order to limit the information within the focus detecting region and enable focus detection in more detailed parts.

Japanese Patent Application Laid-Open No. 2024-052502 does not disclose a method for suppressing differences in object information within the focus detecting region due to differences in the view (angle) of the object. Japanese Patent Application Laid-Open No. 2013-218049 cannot set an optimal focus detecting region in order to match the focus detecting calculation targets in different optical systems.

### SUMMARY

One or more embodiments of a focusing apparatus according to one or more aspects of the disclosure may include one or more memories storing instructions, and one or more processors that, upon execution of the instructions, operate to set a first region used for focus detection in a first image formed via a first optical system and a second region used for focus detection in a second image formed via a second optical system, perform focusing by moving a lens included in at least one of the first and second optical systems, acquire, in a case where a difference between a first defocus amount of the first region and a second defocus amount of the second region is smaller than a first threshold value, a moving amount of the lens based on at least one of the first and second defocus amounts, and change sizes of the first and second regions in a case where the difference is greater than the first threshold value. An image pickup apparatus including the above focusing apparatus also constitutes another aspect of the disclosure. A focusing method corresponding to the above focusing apparatus also constitutes another aspect of the disclosure. A storage medium storing a program that causes a computer to execute the above focusing method also constitutes another aspect of the disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating the functional configuration of an image pickup apparatus as an example of an apparatus having a focusing apparatus according to one embodiment of the disclosure.

FIG. 2 illustrates the configuration of a pixel array on an image sensor.

FIG. 3 is a schematic diagram illustrating an example of the configuration of a lens unit.

FIG. 4 is a flowchart illustrating the imaging processing of the image pickup apparatus.

FIG. 5 is a flowchart illustrating an autofocus (AF) operation.

FIGS. 6A, 6B, 6C, and 6D are schematic diagrams illustrating the difference in view (angle) between left-eye images and right-eye images according to a first embodiment.

FIG. 7 is a flowchart illustrating focus detection processing according to the first embodiment.

FIGS. 8A, 8B, 8C, and 8D are schematic diagrams illustrating a difference in view (angle) between left-eye images and right-eye images according to a second embodiment.

FIG. 9 is a flowchart illustrating focus detection processing according to the second embodiment.

FIG. 10 is a flowchart illustrating selected position change processing according to the second embodiment.

FIGS. 11A, 11B, and 11C are schematic diagrams illustrating a difference in view (angle) between left-eye images and right-eye images according to the third embodiment.

FIG. 12 is a flowchart illustrating focus detection processing according to a third embodiment.

FIGS. 13A, 13B, 13C, and 13D are schematic diagrams illustrating the difference in view (angle) between left-eye and right-eye images according to a fourth embodiment.

FIG. 14 is a flowchart illustrating focus detection processing according to the fourth embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure. Corresponding elements in respective figures will be designated by the same reference numerals, and a duplicate description thereof will be omitted.

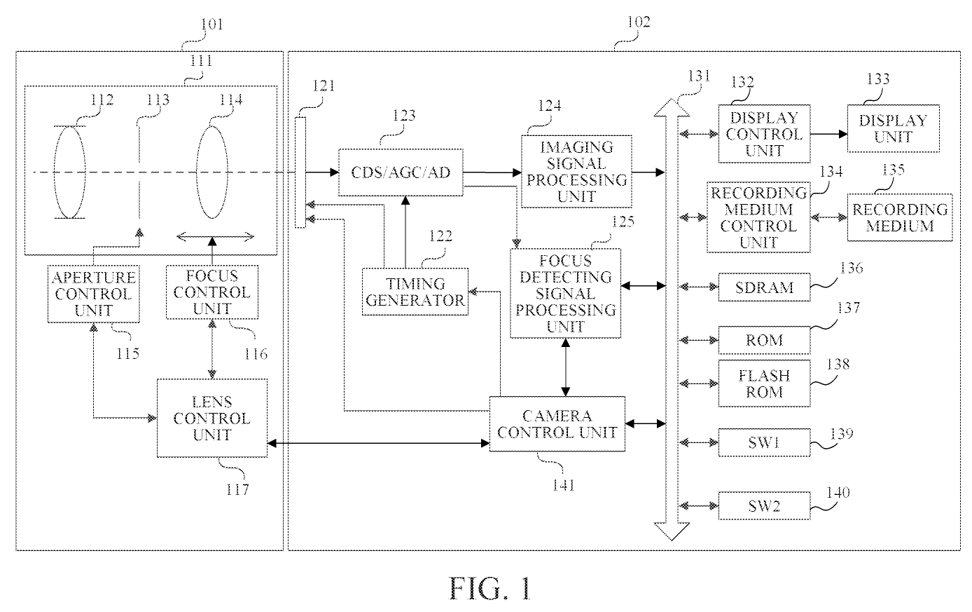

FIG. 1 is a block diagram illustrating the functional configuration of an image pickup apparatus as an example of an apparatus having a focusing apparatus according to one embodiment of the disclosure. The image pickup apparatus includes a lens unit 101 and a camera body 102. A lens control unit 117, which controls the overall operation of the lens unit 101, and a camera control unit (control unit) 141, which controls the overall operation of the image pickup apparatus including the lens unit 101, can communicate with each other via terminals provided on a lens mount.

First, an overview of the configuration and operation of the lens unit 101 will be described. The lens unit 101 is a type of interchangeable lens that can be attached to and detached from the camera body 102. The lens unit 101 is a single lens and is an example of a normal lens. An imaging lens 111 includes a fixed lens 112, an aperture stop (diaphragm) 113, and a focus lens 114. An aperture control unit 115 drives the aperture stop 113 to adjust the aperture diameter of the aperture stop 113 and thereby adjust the light amount during imaging (shooting). The focus lens 114 is a lens that moves during focusing. While FIG. 1 illustrates it simply as a single lens, it typically includes a plurality of lenses. A focus control unit 116 receives a lens moving amount calculated by the camera control unit 141 via the lens control unit 117 and performs focusing by moving the focus lens 114. The AF control is achieved by the focus control unit 116 controlling the focus lens 114. The aperture control unit 115 and focus control unit 116 are controlled by the lens control unit 117.

A description will now be given of the general configuration and operation of the camera body 102. An image sensor 121 includes, for example, a CCD or CMOS sensor, and has a plurality of photoelectric conversion elements that photoelectrically convert an object image (optical image) into electric charges. A light beam incident through the imaging lens 111 is guided to the light receiving surface of the image sensor 121, converted into electric charges in each photoelectric conversion element according to the light amount, and stored. The charges accumulated in each photoelectric conversion element are sequentially read out from the image sensor 121 as voltage signals according to drive pulses output by the timing generator 122.

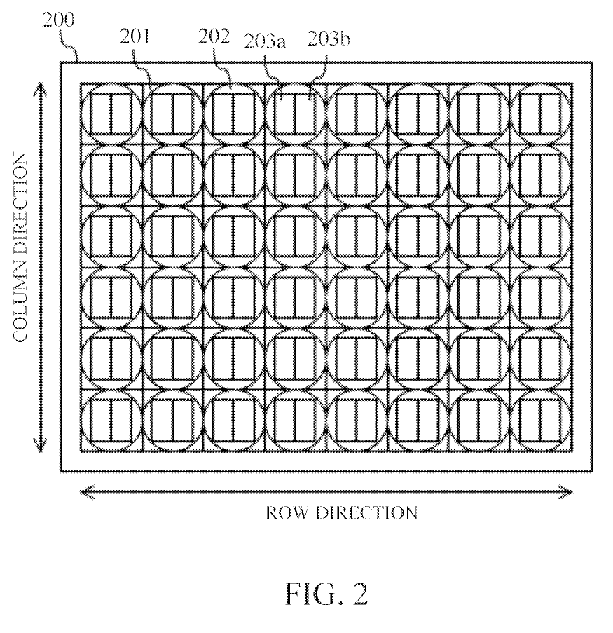

The configuration of the image sensor 121 will now be described with reference to FIG. 2. FIG. 2 illustrates the configuration of a pixel array 200 on the image sensor 121. The pixel array 200 includes unit pixels 201 arranged in a row and column direction. Each unit pixel 201 includes a microlens 202 and photodiodes (PDs) 203a and 203b. The PDs 203a and 203b are arranged under a single microlens 202. Due to this configuration, the PDs 203a and 203b photoelectrically convert light that has passed through different pupil regions of the imaging lens 111, making it possible to capture images of the same object with a phase difference.

An imaging signal can be obtained by adding and reading out the charges accumulated in the PDs 203a and 203b for each unit pixel 201, and a focus detecting signal can be obtained by reading them out independently. Signals corresponding to the charges accumulated in either PD 203a or 203b can also be obtained by reading out and calculating the difference between the sum signal and a signal corresponding to the charges accumulated in either PD 203a or 203b.

Returning to FIG. 1, a CDS/AGC/AD converter 123 performs correlated double sampling to remove reset noise, controls the sensor gain, and digitizes the voltage signals (imaging signal and focus detecting signal) read out from the image sensor 121. The CDS/AGC/AD converter 123 also outputs the processed imaging signal to an imaging signal processing unit 124 and the focus detecting signal to a focus detecting signal processing unit (setting unit) 125.

The focus detecting signal processing unit 125 sets and positions a focus detecting region where focus detection is performed. Here, this is achieved by extracting focus detecting signals output from pixels included in a predetermined region from the focus detecting signals output from the CDS/AGC/AD converter 123. For each focus detecting region, focus detecting signals corresponding to PD 203a are collected to generate an image A, and focus detecting signals corresponding to PD 203b are collected to generate an image B. These are then converted into a pair of image signals with a phase difference, and correlation calculations are performed to determine a defocus amount and reliability information (degree of coincidence between the two images, and the degree of steepness between the two images). While this embodiment discusses focus detection using the so-called imaging-surface phase-difference method, the focus detecting method is not limited to this example, as long as it is a method that can numerically detect the focus state for each focus detecting region. In this embodiment, the focus detecting signal processing unit 125 and the camera control unit 141 form a focusing apparatus.

The imaging signal processing unit 124 performs predetermined image processing, such as gamma conversion processing, white balance processing, and various correction processing, on the imaging signal output from the CDS/AGC/AD converter 123. The processed image data is stored in an SDRAM 136 via a bus 131. The image data stored in the SDRAM 136 is read out by a display control unit 132 via the bus 131 and displayed on a display unit 133. In an operation mode to perform recording, image data stored in the SDRAM 136 is recorded on a recording medium 135 by a recording medium control unit 134.

A ROM 137 stores control programs executed by the camera control unit 141 and various data necessary for control. A flash ROM 138 stores various setting information on the operation of the camera body 102, such as user setting information.

An imaging preparation switch (SW1) 139 is turned on, for example, by half-pressing a shutter release button (not illustrated). This instructs the start of imaging preparation operations such as AF and auto-exposure (AE). After SW1 is turned on, an imaging switch (SW2) 140 is turned on, for example, by fully pressing the shutter release button (not illustrated). This instructs imaging.

The focusing apparatus according to each embodiment includes one or more memories (ROM 137, flash ROM 137) storing instructions, and one or more processors that, upon execution of the instructions, operate to serve as a setting unit (focus detecting signal processing unit 125) and a control unit (camera control unit 141).

The camera control unit 141 determines a lens moving amount based on a defocus amount and reliability information output from the focus detecting signal processing unit 125. The lens moving amount is transmitted to the focus control unit 116 via the lens control unit 117. The focus control unit 116 achieves AF by moving the focus lens 114.

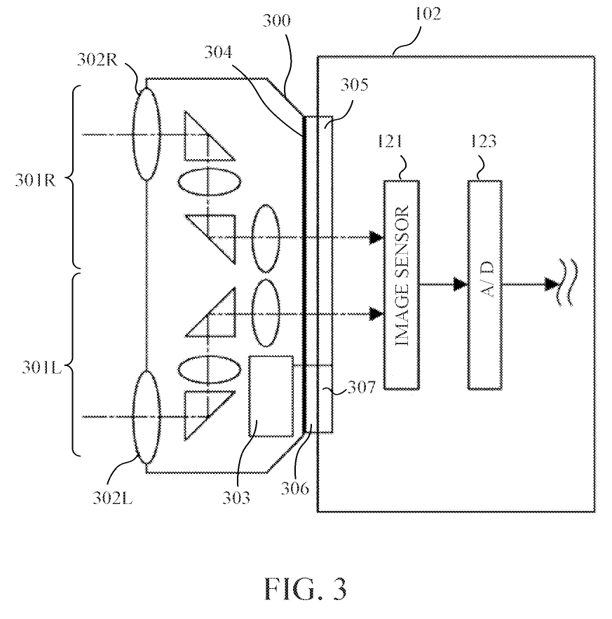

FIG. 3 is a schematic diagram illustrating an example of the configuration of a lens unit 300 that is attached to the camera body 102. Those elements of the camera body 102, which are corresponding elements in FIG. 1, will be designated by the same reference numerals, and a description thereof will be omitted if appropriate.

The lens unit 300 is a type of interchangeable lens that can be attached to and detached from the camera body 102. The lens unit 300 is a twin-lens including two optical systems.

The lens unit 300 includes a right-eye optical system 301R including a plurality of lenses and mirrors, a left-eye optical system 301L including a plurality of lenses and mirrors, and a lens system control circuit 303. The right-eye optical system 301R corresponds to an example of a first optical system, and the left-eye optical system 301L corresponds to an example of a second optical system. The lenses 302R and 302L located on the object side of each of the right-eye optical system 301R and left-eye optical system 301L face the same direction. The lens unit 300 is a VR180 lens for capturing images for VR180, a VR image format that enables two-eye stereoscopic viewing. In a VR180 lens, the right-eye optical system 301R and left-eye optical system 301L each include a fisheye lens that can capture a range of approximately 180 degrees. The VR180 lens may capture images that can be displayed as two-eye VR in VR180 format, and may be a lens that can capture a wide viewing angle range of approximately 160 degrees, which is narrower than the 180-degree range.

The lens for VR180 can form a right-eye image (first image) formed via the right-eye optical system 301R and a left-eye image (second image) formed via the left-eye optical system 301L, which has parallax from the right-eye image, on one or two image sensors of the attached camera. The lens unit 300 includes a focus ring (not illustrated) for focusing. In this embodiment, the lens unit 300 includes a focus ring for focusing of the right-eye image, and a focus ring for focusing of the focus of the left-eye image. The lens unit 300 may include a focus ring for simultaneously performing focusing of the right-eye image and the left-eye image, and a focus ring for performing focusing of either the right-eye image or the left-eye image.

The lens unit 300 is attached to the camera body 102 via a lens mount portion 304 and a camera mount portion 305 of the camera body 102. When the lens unit 300 is attached to the camera body 102, the camera control unit 141 and the lens system control circuit 303 are electrically connected via a communication terminal 307 of the camera body 102 and a communication terminal 306 of the lens unit 300.

In this embodiment, the right-eye image and the left-eye image, which has parallax from the right-eye image, are output side by side by the image sensor 121. That is, two optical images formed by the right-eye optical system 301R and the left-eye optical system 301L are formed on a single image sensor 121. The image sensor 121 converts the formed object image (optical signal) into an analog electrical signal. In this way, using the lens unit 300 can simultaneously acquire (as a set of) two images with parallax from two locations (optical systems), the right-eye optical system 301R and the left-eye optical system 301L. Furthermore, by dividing the acquired image into a left-eye image and a right-eye image and displaying them in VR, the user can view a stereoscopic VR image.

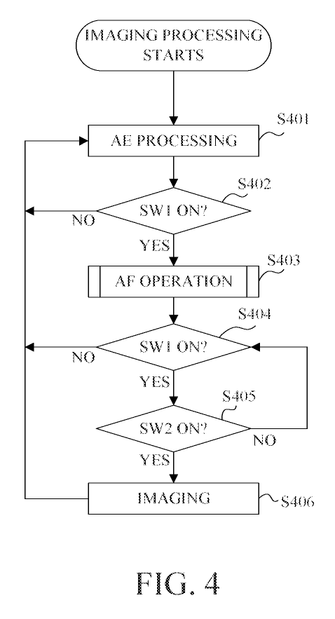

The imaging processing of the camera body 102 will be described below with reference to FIG. 4. FIG. 4 is a flowchart illustrating the imaging processing of the camera body 102. Each step in FIG. 4 is executed by each unit mainly based on instructions from the camera control unit 141.

In step S401, the camera control unit 141 controls the photometry unit (light metering unit, not illustrated) to perform AE processing on the output signal from the imaging signal processing unit 124. In step S402, the camera control unit 141 determines whether the imaging preparation switch 139 (SW1) is turned on. In a case where the camera control unit 141 determines that the imaging preparation switch 139 (SW1) is turned on, it executes the processing of step S403; in a case where it determines that the imaging preparation switch 139 (SW1) is not turned on, it executes the processing of step S401. In step S403, the camera control unit 141 performs the AF operation. In step S404, the camera control unit 141 determines whether the imaging preparation switch 139 (SW1) is turned on. In a case where the camera control unit 141 determines that the imaging preparation switch 139 (SW1) is turned on, it executes the processing of step S405; in a case where it determines that the imaging preparation switch 139 (SW1) is not turned on, it executes the processing of step S401. In step S405, the camera control unit 141 determines whether the imaging switch 140 (SW2) is turned on. In a case where the camera control unit 141 determines that the imaging switch 140 (SW2) is turned on, it executes the processing of step S406; in a case where it determines that the imaging switch 140 (SW2) is not turned on, it executes the processing of step S404. In step S406, the camera control unit 141 performs an imaging operation.

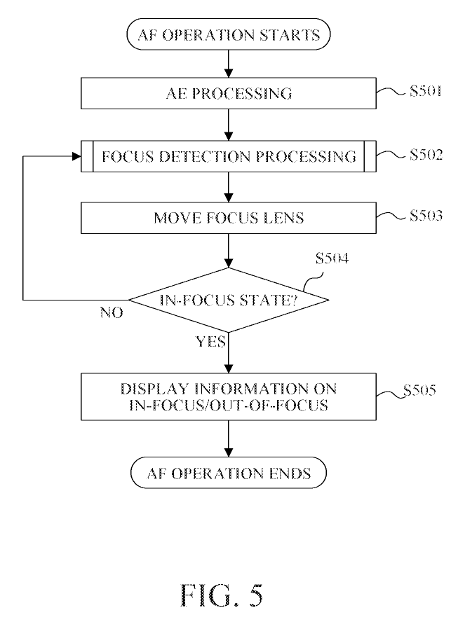

FIG. 5 is a flowchart illustrating the AF operation according to this embodiment. The steps in FIG. 5 are mainly executed by the focus detecting signal processing unit 125 and the camera control unit 141.

In step S501, the camera control unit 141 controls the photometry unit to perform AE processing on the output signal of the imaging signal processing unit 124.

In step S502, the focus detecting signal processing unit 125 performs focus detection processing. More specifically, the focus detecting signal processing unit 125 performs focus detecting calculations using a pair of image signals for each of the right-eye image and the left-eye image, and calculates the defocus amount and reliability. This embodiment assumes that the right-eye optical system 301R and the left-eye optical system 301L have been adjusted for differences in focus detection results due to manufacturing errors, etc., through calibration, etc. Therefore, the focus detection results obtained for the left-eye image and the right-eye image will be approximately the same as long as the focus detecting calculation target is the same.

In step S503, the camera control unit 141 moves the focus lens 114 based on the defocus amount and reliability calculated in step S502.

In step S504, the camera control unit 141 determines whether the focus state is an in-focus state. More specifically, the camera control unit 141 determines whether the defocus amount of the focus detecting region, which is set for each of the right-eye image and the left-eye image, is smaller than a threshold value (third threshold value). In a case where each defocus amount is smaller than a threshold value, the camera control unit 141 determines that the focus state is the in-focus state; otherwise, it determines that the focus state is the in-focus state. In a case where the camera control unit 141 determines that the camera is in focus, it executes step S505. In a case where the camera control unit 141 determines that the focus state is an out-of-focus state, it executes step S502.

In step S505, the camera control unit 141 displays information about in-focus/out-of-focus on the display unit 133.

The focus detection processing of step S502 in FIG. 5 for each embodiment is described below.

### FIRST EMBODIMENT

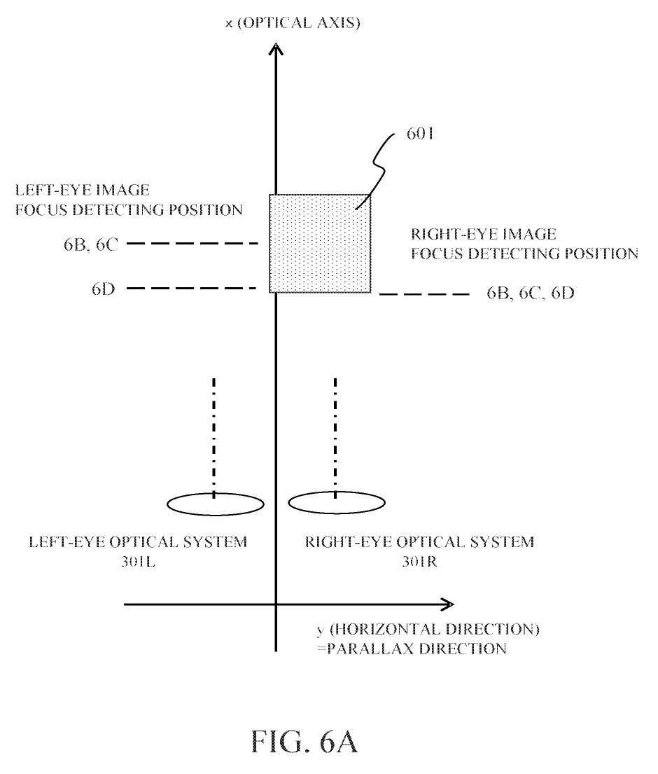

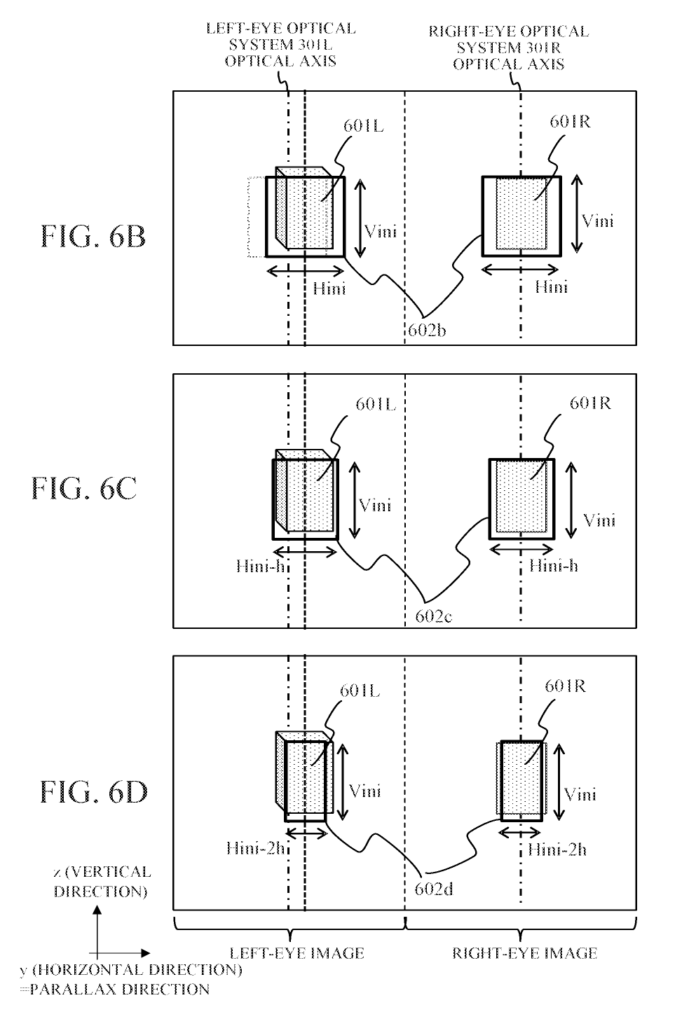

FIGS. 6A, 6B, 6C, and 6D are schematic diagrams illustrating a difference in view (angle) between left-eye and right-eye images, and schematically illustrate a rectangular parallelepiped 601 viewed through a plurality of optical systems (right-eye optical system 301R and left-eye optical system 301L). FIG. 6A is a top view. FIGS. 6B, 6C, and 6D illustrate live-view images on the display unit 133, in which the display control unit 132 superimposes the focus detecting region as an AF frame (602b, 602c, and 602d) on the display image output from the imaging signal processing unit 124. This embodiment assumes that the shift in the focus detecting position region due to parallax is corrected using any known method. That is, in FIGS. 6B, 6C, and 6D, due to parallax, the horizontal center of the rectangular parallelepiped 601 in the right-eye image is located on the optical axis (an alternate long and short dash line) of the right-eye optical system 301R (601R). In the left-eye image, it appears shifted to the right of the optical axis (an alternate long and short dash line) of the left-eye optical system 301L (601L). The focus detecting position of the left-eye image is corrected based on this shift due to parallax. In this embodiment, the focus detecting position of the left-eye image is corrected using the right-eye image as the reference image. However, the focus detecting position of the right-eye image may also be corrected using the left-eye image as the reference image.

As described above, correcting the shift of the focus detecting region due to parallax can perform focus detecting calculations on the same object. However, as illustrated in FIGS. 6B, 6C, and 6D, the view (angle) of the rectangular parallelepiped 601 may be different between the left-eye image and the right-eye image. In this case, in the left-eye image, the rectangular parallelepiped 601 is viewed from the left side, so the left side of the rectangular parallelepiped 601 can be viewed (601L). On the other hand, in the right-eye image, the rectangular parallelepiped 601 is viewed from approximately the front, so only the front of the rectangular parallelepiped 601 can be viewed (601R). In this case, as illustrated in FIG. 6B, in a case where a focus detecting region 602b larger than the rectangular parallelepiped 601 is set, the focus detecting calculations will be performed using object information for only the front of the rectangular parallelepiped 601 in the right-eye image, but the focus detecting calculations are performed that include object information for the side of the rectangular parallelepiped 601 in the left-eye image. In other words, since the object information contained in the focus detecting region differs between the left and right, differences occur between the left and right focus detection results, resulting in a difference in focus detecting position, as illustrated in FIG. 6A. In FIG. 6C, the focus detecting region is set smaller in the horizontal direction (parallax direction) than in FIG. 6B (602c). However, since the side of the rectangular parallelepiped 601 is included in the focus detecting region for the left-eye image, a difference in focus detecting position occurs between the left and right, as in FIG. 6B. In FIG. 6D, the focus detecting region is set smaller in the horizontal direction (parallax direction) than in FIG. 6C. In FIG. 6D, the side of the rectangular parallelepiped 601 is not included in the focus detecting region for the left-eye image, and focus detecting calculations can be performed using object information equivalent to that in the right-eye image (the front surface of the rectangular parallelepiped 601). Therefore, as illustrated in FIG. 6A, the focus detecting positions match between the left and right. As illustrated in FIGS. 6B and 6C, when a difference occurs between the focus detection results for the left and right-eye images, it is impossible to determine which focus detection result (defocus amount) should be used to move the focus lens 114. If the focus lens 114 is moved to the average focus detecting position between the left and right, or if the focus lens 114 is moved to the focus detecting position with less object information, the accuracy of the focus detecting position deteriorates.

Thus, in the case of FIGS. 6A to 6D, in order to match the focus detecting calculation targets between the left and right, it is necessary to set the focus detecting region as illustrated in FIG. 6D.

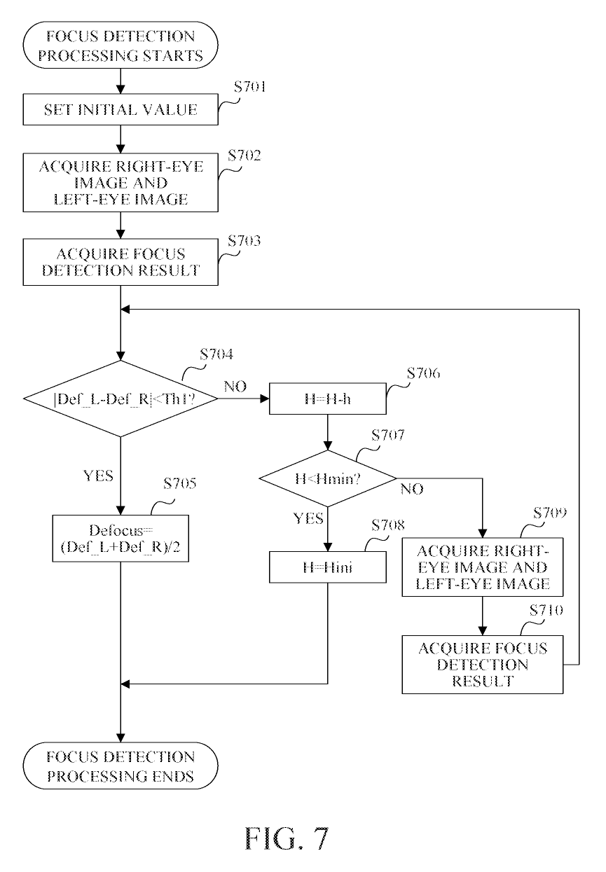

The focus detection processing up to FIG. 6D will be described below with reference to FIG. 7. FIG. 7 is a flowchart of the focus detection processing according to this embodiment.

In step S701, the focus detecting signal processing unit 125 sets the horizontal size H and vertical size V of focus detecting region to initial values Hini and Vini, respectively. The focus detecting signal processing unit 125 also sets a lens moving amount (defocus amount) Defocus, which is used to move the focus lens 114 in step S503 of FIG. 5, to an initial value of 0 (the state of FIG. 6B).

In step S702, the focus detecting signal processing unit 125 acquires a left-eye image and a right-eye image.

In step S703, the focus detecting signal processing unit 125 acquires the results of the focus detecting calculations for the left-eye image and the right-eye image (Defocus_L, Defocus_R) and stores them as focus detection results (Def_L, Def_R). The focus detecting signal processing unit 125 also stores the focus detection result Def_R of the right-eye image, which is the reference image, as the lens moving amount Defocus.

In step S704, the focus detecting signal processing unit 125 determines whether a Defocus difference, which is the magnitude of the difference between the left and right focus detection results (Def_L, Def_R), is smaller than a threshold value (first threshold value) Th1. In a case where the focus detecting signal processing unit 125 determines that the Defocus difference is smaller than the threshold value Th1, i.e., that the left and right object information match, it executes the processing of step S705. In a case where the focus detecting signal processing unit 125 determines that the Defocus difference is greater than the threshold value Th1, it executes the processing of step S706. In a case where the Defocus difference is equal to the threshold value Th1, it is possible to arbitrarily set which step to execute.

In step S705, the focus detecting signal processing unit 125 stores the average of the left and right focus detection results (Def_L, Def_R) as the lens moving amount Defocus.

In step S706, the focus detecting signal processing unit 125 changes the focus detecting region so that the horizontal size H of the focus detecting region is reduced by a change amount h (the state illustrated in FIG. 6C).

In step S707, the focus detecting signal processing unit 125 determines whether the changed horizontal size H is smaller than the lower limit Hmin of the horizontal size H. In a case where the focus detecting signal processing unit 125 determines that the horizontal size H is smaller than the lower limit Hmin, i.e., changing the horizontal size H did not make the left and right object information identical, it executes the processing of step S708. In a case where the focus detecting signal processing unit 125 determines otherwise, it executes the processing of step S709.

In step S708, the focus detecting signal processing unit 125 sets the horizontal size H to the initial value Hini. In this case, in step S503 of FIG. 5, the focus lens 114 is moved by the lens moving amount Defocus set in step S703, i.e., the focus detection result Def_R for the right-eye image calculated using the initial focus detecting region (Hini, Vini). In step S505, an AF frame is displayed with the size of the focus detecting region set in steps S701 and S708.

In step S709, the focus detecting signal processing unit 125 acquires the left-eye image and the right-eye image.

In step S710, the focus detecting signal processing unit 125 acquires the calculation results of the left and right focus detections (Defocus_L, Defocus_R). In a case where it is determined in step S704 that the Defocus difference is equal to or less than the threshold value Th1 (the state of FIG. 6D), the lens moving amount Defocus is acquired in step S705. In this case, in step S503 of FIG. 5, the focus lens 114 is moved using the lens moving amount Defocus acquired in step S705. Also, in step S505, an AF frame is displayed with the size of the focus detecting region changed in step S706. This makes it possible to clearly show the user which part of the object is in focus.

Here, the threshold value Th1 used in step S704 may be equal to or less than the level at which a difference in focus state cannot be visually recognized, so it may be equal to or less than 1Fδ. The threshold value Th1 may also be changed according to the defocus amount and reliability information. Particularly, in a case where the focus state is near the in-focus state (a state in which the defocus amount is small and reliability is high), the threshold value Th1 may be smaller because the error (variation) in the focus detecting calculation results is small. More specifically, the threshold value Th1 may be equal to or less than the threshold value of the defocus amount used as a focus determination condition so as not to affect the focus state (in-focus/out-of-focus) determination.

Furthermore, since the horizontal size H is smaller than a necessary amount in step S706, the accuracy of the focus detecting calculation (reliability information) deteriorates, it may be gradually reduced. Therefore, the change amount h may be set to a value approximately 20% or less of the initial value Hini of the horizontal size H of the focus detecting region. Thereby, the proper adjustment can be achieved to a horizontal size that matches the object information in the left and right focus detecting regions while the accuracy of the focus detecting calculation is maintained.

In step S707, a lower limit Hmin of the horizontal size H that does not excessively reduce the accuracy (reliability information) of the focus detecting calculation may be set. Setting the lower limit Hmin too small can result in problems such as too little information in the focus detecting region, and focus detecting calculations cannot be achieved. Therefore, the lower limit Hmin may be set to a value approximately 30% of the initial value Hini of the horizontal size H of the focus detecting region.

In this embodiment, the set value for the lens moving amount Defocus when it is determined in step S704 that the condition is met is the average of the left and right focus detection results (Def_L, Def_R), but this disclosure is not limited to this example. In a case where it is determined in step S704 that the condition is met, the left and right focus detection results are sufficiently small, so it is not a problem to use only one of the focus detection results.

As described above, the configuration of this embodiment compares the defocus difference between the left and right images and adjusts the horizontal size of the focus detecting region. Thereby, this embodiment can suppress a difference in view (angle) of the object due to parallax and improve focus detection accuracy.

### SECOND EMBODIMENT

In this embodiment, a focus detecting calculation region is selected based on a defocus amount and reliability information from a plurality of focus detection results obtained by dividing the focus detecting region 802.

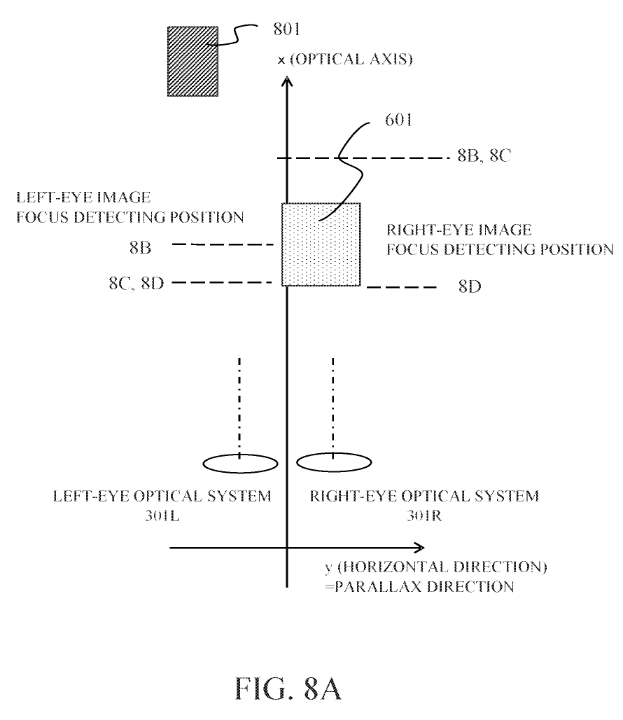

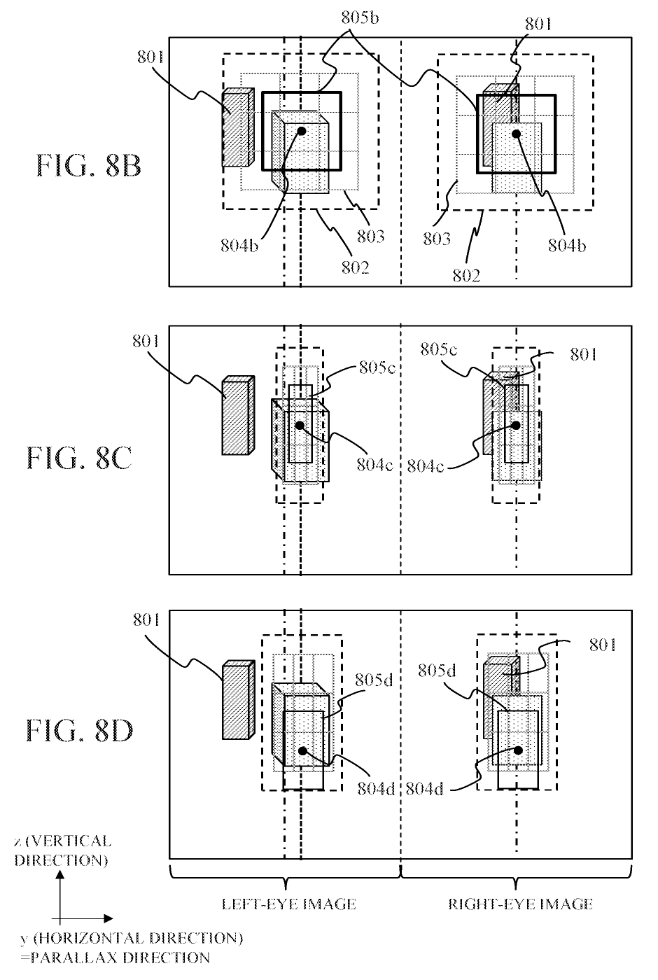

FIGS. 8A, 8B, 8C, and 8D are schematic diagrams illustrating a difference in view (angle) between left-eye and right-eye images, and schematically illustrate a case in which another rectangular parallelepiped 801 is located behind the rectangular parallelepiped 601 in FIGS. 6A, 6B, 6C, and 6D. FIG. 8A is a top view, and FIGS. 8B, 8C, and 8D illustrate images displayed on the display unit 133. A grating 803 indicates a plurality of focus detecting calculation positions when the focus detecting region 802 is divided horizontally into A and vertically into B. Selection positions 804b, 804c, and 804d, indicated by black dots, indicate the centers of focus detecting calculation regions 805b, 805c, and 805d, which include a plurality of selected positions. For description convenience, the focus detecting calculation position ID of the upper left corner of the grating 803 is set to 0 (horizontal: 0, vertical: 0), and the focus detecting calculation position ID of the lower right corner is set to A×B-1 (A-1, B-1). FIGS. 8B, 8C, and 8D illustrate the case where A = 3 and B = 3. The focus detecting position IDs of the selected positions 804b and 804c are 4 (1, 1), and the focus detecting calculation position ID of the selected position 804d is 7 (1, 2). In this case, in FIGS. 8B and 8C, only the right-eye image includes a rectangular parallelepiped 801 within the focus detecting calculation regions 805b and 805c. Therefore, even if the focus detecting calculation regions 805b and 805c are reduced in the horizontal direction as in FIGS. 8B and 8C, the object information within the focus detecting calculation regions of the left-eye image and the right-eye image does not match, resulting in a difference in focus detecting position, as illustrated in FIG. 8A. On the other hand, in FIG. 8D, the selected position 804d, one position lower than that in FIGS. 8B and 8C, is selected, so the rectangular parallelepiped 801 is not included in the focus detecting calculation region 805d. Therefore, by reducing the focus detecting calculation region 805d in the horizontal direction, the object information becomes equivalent between the left and right (the front of the rectangular parallelepiped 601), and the focus detecting positions match between the left-eye image and the right-eye image, as illustrated in FIG. 8A.

From the above, in the cases of FIGS. 8A, 8B, 8C, and 8D, in order to match the focus detecting calculation targets on the left and right, it is necessary to set the focus detecting calculation region 805d as illustrated in FIG. 8D.

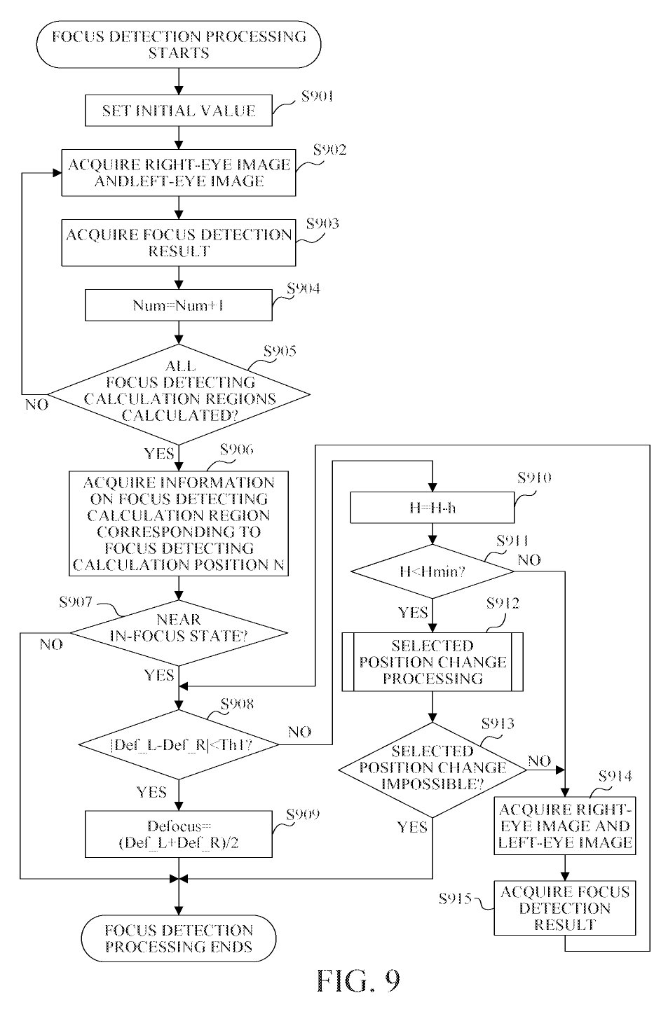

The focus detection processing up to FIG. 8D will be discussed below with reference to FIG. 9. FIG. 9 is a flowchart illustrating the focus detection processing according to this embodiment.

In step S901, the focus detecting signal processing unit 125 sets initial values to the horizontal size H, vertical size V, focus detecting calculation position ID: Num (horizontal: i, vertical: j), and defocus amount Defocus used in step S503 of the focus detecting region.

In step S902, the focus detecting signal processing unit 125 acquires a left-eye image and a right-eye image.

In step S903, the focus detecting signal processing unit 125 acquires the focus detecting calculation results (Defocus_L, Defocus_R) for the left-eye image and the right-eye image, and stores them as focus detection results (Def_L(Num), Def_R(Num)).

In step S904, the focus detecting signal processing unit 125 counts up the focus detecting calculation position ID: Num.

In step S905, the focus detecting signal processing unit 125 determines whether calculation has been completed for all focus detecting calculation regions. In a case where the focus detecting signal processing unit 125 determines that calculation has been completed for all focus detecting calculation regions, it executes the processing of step S906; in a case where it determines that calculation has not been completed, it executes the processing of step S902.

In step S906, the focus detecting signal processing unit 125 retains information about the focus detecting calculation region corresponding to the focus detecting calculation position N selected based on the focus detection results.

In step S907, the focus detecting signal processing unit 125 determines whether the focus state is near the in-focus state based on the focus detection results. More specifically, the focus detecting signal processing unit 125 determines whether the defocus amount of the focus detecting region (focus detecting calculation regions) set for each of the right-eye image and the left-eye image is smaller than a threshold value (fourth threshold value). In a case where the defocus amount is smaller than the threshold value, the camera control unit 141 determines that the focus state is close to the in-focus state; otherwise, it determines that the focus state is not close to the in-focus state. In a case where the focus detecting signal processing unit 125 determines that the focus state is near the in-focus state, it executes the processing of step S908. In a case where the focus detecting signal processing unit 125 determines that the focus state is not near the in-focus state, this flow ends, and then the focus detecting signal processing unit 125 moves the focus lens 114 and displays the AF frame using the information set in step S906.

The processing in steps S908 to S910 is similar to the processing in steps S704 to S706 in FIG. 7, and thus a description thereof will be omitted.

In step S911, the focus detecting signal processing unit 125 determines whether the changed horizontal size H is smaller than the lower limit Hmin of the horizontal size H. In a case where the focus detecting signal processing unit 125 determines that the horizontal size H is smaller than the lower limit Hmin, it executes the processing of step S912; in a case where it determines that the horizontal size H is not smaller than the lower limit Hmin, it executes the processing of step S914.

In step S912, the focus detecting signal processing unit 125 executes selected position change processing to change the focus detecting calculation position.

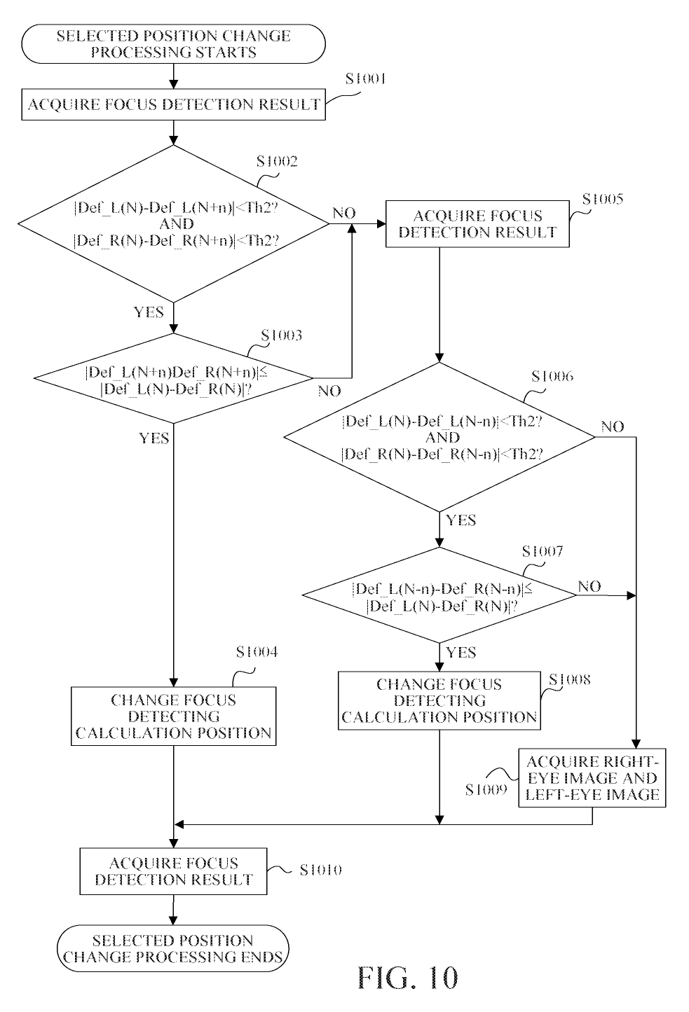

Now, the selected position change processing will be described with reference to FIG. 10. FIG. 10 is a flowchart illustrating the selected position change processing.

In step S1001, the focus detecting signal processing unit 125 acquires the focus detection results (Def_L(N), Def_R(N)) in the focus detecting calculation region corresponding to the current focus detecting calculation position ID: N. The focus detecting signal processing unit 125 acquires the focus detection results (Def_L(N+n), Def_R(N+n)) in the focus detecting calculation region corresponding to the focus detecting calculation position ID: N+n, which is the candidate position to be selected next.

In step S1002, the focus detecting signal processing unit 125 determines whether the magnitude of the difference (Defocus difference) between the focus detection results of the current focus detecting calculation region and the candidate focus detecting calculation region on the left and right is smaller than a threshold value (second threshold value) Th2. In a case where the focus detecting signal processing unit 125 determines that the Defocus difference is smaller than the threshold value Th2, i.e., that the same object is being calculated for the current and candidate focus detecting calculation regions, it executes the processing of step S1003. In a case where the focus detecting signal processing unit 125 determines that at least one of the Defocus differences is equal to or greater than the threshold value Th2, i.e., that different objects are being calculated for the current and candidate focus detecting calculation regions, it executes the processing of step S1005.

In step S1003, the focus detecting signal processing unit 125 compares the magnitude of the difference between the left and right focus detection results for the current and candidate focus detecting calculation regions (left and right defocus difference), i.e., the left and right object information. More specifically, the focus detecting signal processing unit 125 determines whether the left and right defocus difference for the candidate focus detecting calculation region is equal to or smaller than the left and right defocus difference for the current focus detecting calculation region. This makes it possible to determine whether the degree of coincidence of the object information between the left and right in the candidate focus detecting calculation region has deteriorated. In a case where the focus detecting signal processing unit 125 determines that the left and right defocus difference of the candidate focus detecting calculation region is equal to or less than the left and right defocus difference of the current focus detecting calculation region, it executes the processing of step S1004. In a case where the focus detecting signal processing unit 125 determines otherwise, it executes the processing of step S1005.

In step S1004, the focus detecting signal processing unit 125 changes the focus detecting calculation position ID from N to N+n.

In step S1005, the focus detecting signal processing unit 125 acquires the focus detection results (Def_L(N-n), Def_R(N-n)) in the focus detecting calculation region corresponding to the focus detecting calculation position ID: N-n, which is a candidate position different from that in step S1001.

In step S1006, the focus detecting signal processing unit 125 determines whether the magnitude of the difference (defocus difference) between the focus detection results of the current focus detecting calculation region and the candidate focus detecting calculation region on the left and right is smaller than the threshold value Th2. In a case where the focus detecting signal processing unit 125 determines that the Defocus difference is smaller than the threshold value Th2, it executes the processing of step S1007, and in a case where it determines that at least one of the Defocus differences is equal to or greater than the threshold value Th2, it executes the processing of step S1009.

In step S1007, the focus detecting signal processing unit 125 compares the magnitude of the difference between the left and right focus detection results of the current and candidate focus detecting calculation regions (left and right defocus difference), i.e., the left and right object information. In a case where the focus detecting signal processing unit 125 determines that the left and right defocus difference of the candidate focus detecting calculation region is equal to or less than the left and right defocus difference of the current focus detecting calculation region, it executes the processing of step S1008. In a case where the focus detecting signal processing unit 125 determines otherwise, it executes the processing of step S1009.

In step S1008, the focus detecting signal processing unit 125 changes the focus detecting calculation position ID from N to N-n.

In step S1009, the focus detecting signal processing unit 125 determines that the selected position cannot be changed.

In step S1010, the focus detecting signal processing unit 125 sets the size of the focus detecting calculation region to the initial value and executes step S913 of FIG. 9.

In steps S1001 and S1005, in a case where candidate focus detecting calculation positions are selected from positions in the parallax direction (horizontal direction) from the current focus detecting calculation position, a difference between the focus detecting calculation targets on the left and right may increase. Therefore, positions in the direction orthogonal to the parallax (vertical direction) may be selected. That is, positions obtained by changing the vertical j may be selected, with candidate focus detecting calculation position ID: N+n and N-n for the current focus detecting calculation position ID: N (horizontal i, vertical j). In this embodiment, the focus detecting region 802 is divided into 3×3 in FIGS. 8A, 8B, 8C, and 8D, and two, upper and lower, candidate focus detecting calculation positions are assumed (n = 3). However, searching from all focus detecting calculation positions in the direction orthogonal to the parallax (vertical direction) may be used. In a case where a distance between focus detecting calculation positions in the horizontal direction is set narrow, the influence of parallax is small even when the horizontal i is changed, so the candidate focus detecting calculation positions may be assumed to two, left and right, positions among the current focus detecting calculation positions.

Since it is necessary to determine that the objects are the same, the threshold value Th2 used in step S1002 may be approximately 50 mm or less. While this embodiment illustrates an example in which candidate focus detecting calculation positions are selected one by one, a plurality of focus detecting calculation positions may be selected and the horizontal size adjustment flow may be executed. For example, when the number of divisions (A, B) is large, searching from the plurality of focus detecting calculation positions is useful because it allows for a more optimal focus detecting calculation position to be changed.

In step S913, the focus detecting signal processing unit 125 determines whether the selected position cannot be changed in the selected position change processing. In a case where the focus detecting signal processing unit 125 determines that the selected position cannot be changed, this flow ends; otherwise, it executes the processing of step S914.

The processing of steps S914 and S915 is similar to the processing of steps S709 and S710 in FIG. 7, respectively, and a description thereof will be omitted.

This embodiment illustrates an example in which it is determined in step S907 whether the focus state is near the in-focus state, and the horizontal size is changed only if the focus state is near the in-focus state. In selecting a focus detecting calculation region from a plurality of focus detection results obtained by dividing the focus detecting region 802, the object to be focused on is generally not determined in a blurred state, and the focus detecting position fluctuates. Therefore, the effects of the disclosure are achieved only near the in-focus state where the focus detecting calculation position is determined. As described above, focus detection variation is small near the in-focus state, and the defocus difference is effectively determined. Therefore, in other embodiments, as in this embodiment, the horizontal size may be changed only near the in-focus state.

As described above, the configuration of this embodiment, when selecting a focus detecting calculation region from a plurality of focus detection results, can adjust the horizontal size of the focus detecting calculation region, suppress a difference in view (angle) of the object due to parallax, and improve focus detection accuracy.

### THIRD EMBODIMENT

This embodiment discusses the case where the eye of a person 1101 is detected during object detection (pupil focus detection).

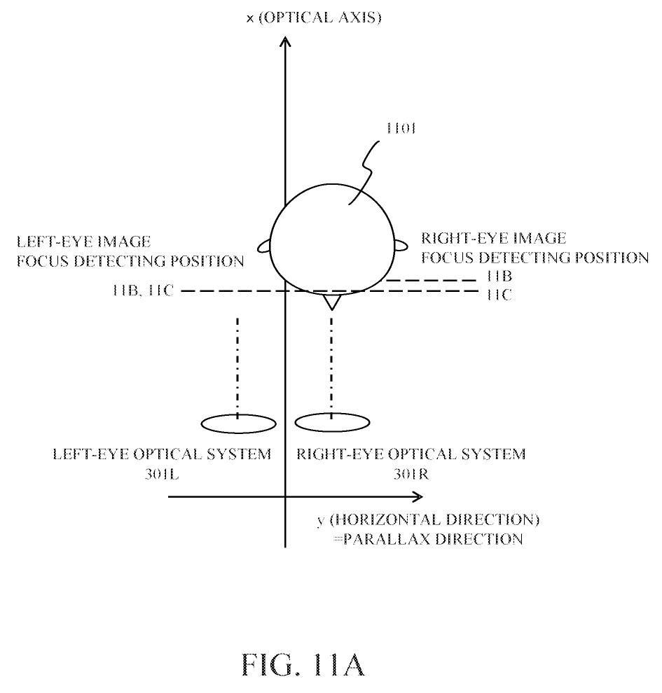

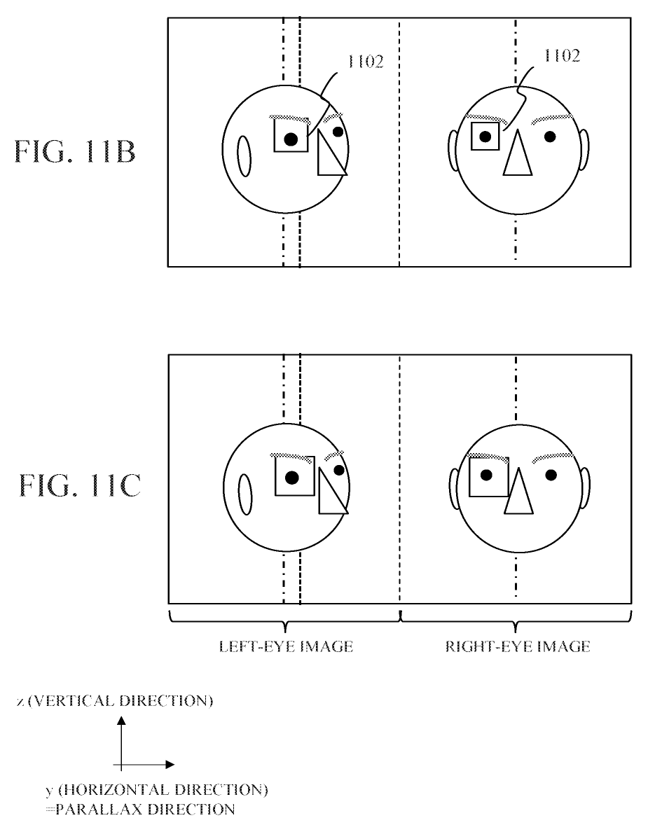

FIGS. 11A, 11B, and 11C are schematic diagrams illustrating the difference in view (angle) between left-eye and right-eye images, and schematically illustrate the person 1101 viewed through a plurality of optical systems (right-eye optical system 301R and left-eye optical system 301L). FIG. 11A is a top view, and FIGS. 11B and 11C illustrate images displayed on the display unit 133.

In FIG. 11B, the focus detecting region is set based on the detected pupil size. In this case, object information within the focus detecting region is limited to the vicinity of the pupil. Here, the focus detecting region in the right-eye image contains object information for only the pupil, while the focus detecting region in the left-eye image contains object information that extends to the eyebrow. Therefore, as illustrated in FIG. 11A, the right-eye image provides focus detection result for the pupil position, but the left-eye image results in a focus detecting position that is slightly further forward. When the focus detecting region is prone to becoming small, as in pupil focus detection, even if the horizontal size H is reduced as in the first and second embodiments, there is a high possibility that focus detection will become impossible due to too little object information. Furthermore, in the case of pupil focus detection, the information around the pupil is facial features (eyebrows, cheeks, and nose), so by expanding the focus detecting region, as illustrated in FIG. 11C, it is possible to match the left and right object information.

Thus, in the case of FIGS. 11A to 11C, in order to match the left and right focus detecting calculation targets, it is necessary to set the focus detecting region of FIG. 11C.

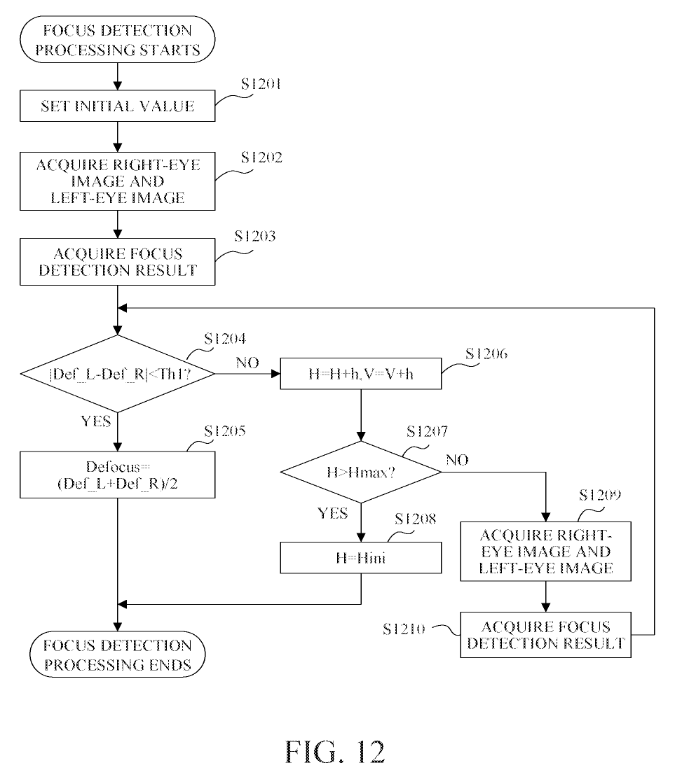

The focus detection processing up to FIG. 11C will be described below with reference to FIG. 12. FIG. 12 is a flowchart illustrating the focus detection processing according to this embodiment.

In step S1201, the focus detecting signal processing unit 125 sets initial values (Hini, Vini, 0) for the horizontal size H and vertical size V of the focus detecting region and the defocus amount Defocus used in step S503. The initial values (Hini, Vini) at this time are the pupil size (the state of FIG. 11B).

The processing of steps S1202 to S1205 is similar to the processing of steps S702 to S705 in FIG. 7, respectively, and thus a description thereof will be omitted.

In step S1206, the focus detecting signal processing unit 125 changes the focus detecting region so that the horizontal size H and vertical size V of the focus detecting region are increased by the change amount h (the state of FIG. 11C).

In step S1207, it is determined whether the horizontal size H is higher than the upper limit Hmax of the horizontal size H. In a case where the focus detecting signal processing unit 125 determines that the horizontal size H is higher than the upper limit Hmax, it executes the processing of step S1208. In a case where it determines that the horizontal size H is not higher than the upper limit Hmax, it executes the processing of step S1209. The upper limit Hmax may be set to a size approximately twice the pupil size, based on the perspective conflict with the background.

In step S1208 to step S1210, the processing is similar to the processing of steps S708 to S710 in FIG. 7, and thus a description thereof will be omitted.

While the focus detecting region is enlarged by the same amount in both the horizontal and vertical directions in this embodiment, the same effect can be achieved by changing a change amount in either the horizontal or vertical direction. Furthermore, increasing the size in the vertical direction can further suppress the parallax influence in the horizontal direction. This is effective for profile and oblique faces.

As described above, the configuration of this embodiment can adjust the horizontal size of the focus detecting region to be larger during pupil detection, and perform focus detecting calculations using average face information. This reduces a difference in view (angle) of the object due to parallax and improves focus detection accuracy.

### FOURTH EMBODIMENT

This embodiment discusses the case where a vehicle such as a train, car, or airplane, or an object with depth, such as the entire body of an animal or a human face, is detected. This embodiment uses a train as an example.

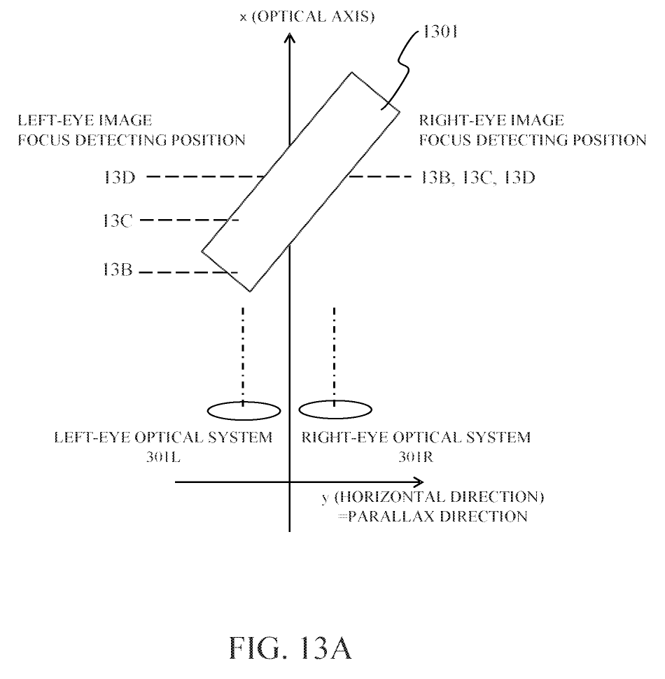

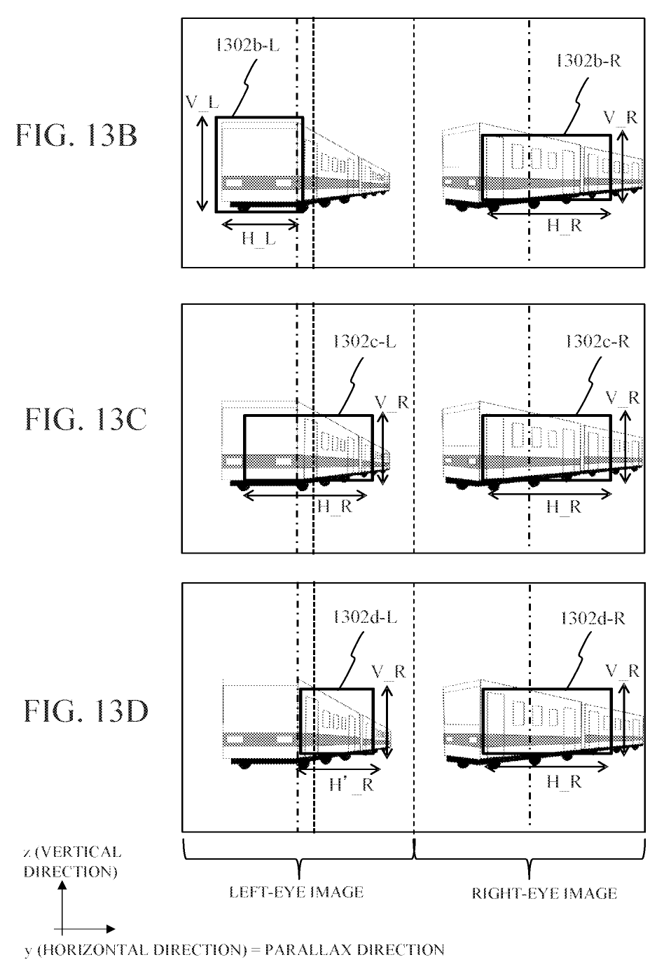

FIGS. 13A, 13B, 13C, and 13D are schematic diagrams illustrating a difference in view (angle) between left-eye and right-eye images in this embodiment, and schematically illustrate a train 1301 viewed through a plurality of optical systems (right-eye optical system 301R and left-eye optical system 301L). FIG. 13A is a top view, and FIGS. 13B, 13C, and 13D illustrate images displayed on the display unit 133.

In FIG. 13B, the left-eye image contains a large proportion of the front of the train, so the front of the train is detected, while the right-eye image contains a smaller proportion of the front of the train, so the side of the train is detected. When focus detecting calculations are performed at each position and size, a difference occurs in the focus detection position, as illustrated in FIG. 13A. In FIG. 13C, the position and size of the focus detecting region in the left-eye image have been changed to match the right-eye image (reference). At this time, since information about the side of the train is also included in the focus detecting region of the left-eye image, the left and right focus detecting positions become closer as illustrated in FIG. 13A. However, there is still a difference in focus detecting positions due to the presence or absence of information about the front of the train. In FIG. 13D, the focus detecting region is set to be smaller in the horizontal direction (parallax direction) from the state in FIG. 13C. In this embodiment, the size is reduced by moving it in the direction in which the focus detecting position was changed in FIG. 13C (toward the right of the screen). In other words, the size and center position of the focus detecting region are changed so that the right edge position of the focus detecting region does not change. This makes it easier to match the information within the focus detecting region of the right-eye image. This method can match the focus detecting positions between the left-eye image and the right-eye image, as illustrated in FIG. 13A.

Based on the above, in the cases of FIGS. 13B, 13C, and 13D, in order to match the focus detecting calculation targets on the left and right, it is necessary to set the focus detecting region as illustrated in FIG. 13D.

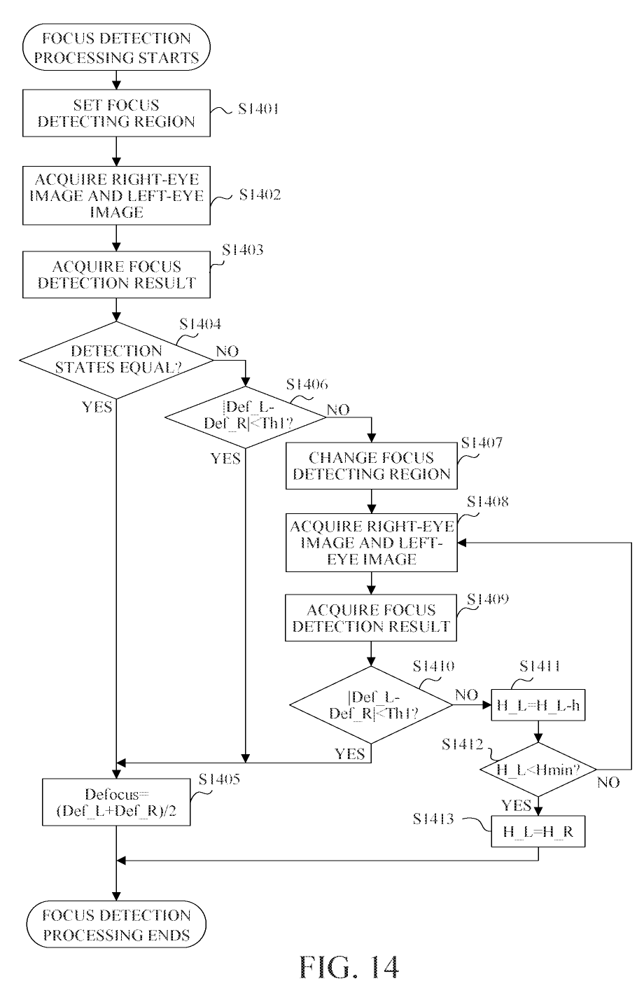

The focus detection processing up to FIG. 13C will be discussed below with reference to FIG. 14. FIG. 14 is a flowchart illustrating the focus detection processing according to this embodiment.

In step S1401, the focus detecting signal processing unit 125 sets the detection results for the left and right focus detecting regions to the horizontal size H_L, H_R, vertical size V_L, V_R, horizontal coordinates X_L, X_R, and vertical coordinates Y_L, Y_R (the state illustrated in FIG. 13B). The focus detecting signal processing unit 125 also sets the defocus amount Defocus used in step S503 to an initial value of 0.

The processing of steps S1402 and S1403 is similar to the processing of steps S702 and S703 in FIG. 7, and thus a description thereof will be omitted.

In step S1404, the focus detecting signal processing unit 125 compares the detection results of the left-eye image and the right-eye image to determine whether the detection states are equal. In a case where the focus detecting signal processing unit 125 determines that the detection states are equal, it executes the processing of step S1405; otherwise, it executes the processing of step S1406.

The processing of steps S1405 and S1406 is similar to the processing of steps S705 and S704 in FIG. 7, respectively, and thus a description thereof will be omitted.

In step S1407, the focus detecting signal processing unit 125 changes the focus detecting region of the left-eye image to the same focus detecting region as that of the right-eye image (the state of FIG. 13C).

In steps S1408 to S1410, the processing is similar to the processing of steps S702 to S704 in FIG. 7, and thus a description thereof will be omitted.

In step S1411, the focus detecting signal processing unit 125 changes the horizontal size H_L of the focus detecting region of the left-eye image so that it is reduced by the amount h (the state of FIG. 13D).

In step S1412, the focus detecting signal processing unit 125 determines whether the horizontal size H_L of the left-eye image changed in step S1411 is lower than the lower limit Hmin of the horizontal size H_L. In a case where the focus detecting signal processing unit 125 determines that the horizontal size H_L is lower than the lower limit Hmin, it executes the processing of step S1413; otherwise, it executes the processing of step S1408.

In step S1413, the focus detecting signal processing unit 125 sets the horizontal size H_L to the horizontal size H_R of the right-eye image. In this case, in steps S503 and S505 of FIG. 5, the detection result of the right-eye image is used to move the focus lens 114 and display the AF frame based on the result of focus detecting calculations for the left and right-eye images.

Inherently, when object detection is performed on left and right images separately, information within the focus detecting region is likely to match, and a difference is unlikely to occur in the left and right focus detection results. However, as in this embodiment, in cases where there is a detection error or the detection results are unstable near the threshold value for determining the detection state (a difference occurs between the left and right), the focus detection accuracy can be improved using the methods of the third embodiment and this embodiment.

As discussed above, the configuration according to this embodiment, when detecting an object with depth, matches the detection states of the left and right objects, and then adjusts the horizontal size of the focus detecting region. This can suppress a difference in view (angle) of the object due to parallax, and improve the focus detection accuracy.

### OTHER EMBODIMENTS

Embodiment(s) of the disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like. One or more of the functional blocks illustrated in FIG. 1 may be implemented by hardware such as an ASIC or a programmable logic array (PLA), or by a programmable processor such as a CPU or MPU executing software. They may also be implemented by a combination of software and hardware. Therefore, even when different functional blocks are described as the main operation entities in the following description, they may be implemented by the same hardware.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each embodiment can provide a focusing apparatus that can suppress a difference in view of an object due to parallax and improve the focus detection accuracy.

This application claims the benefit of Japanese Patent Application No. 2025-012845, filed on January 29, 2025, which is hereby incorporated by reference herein in its entirety.

What is claimed is:

1. A focusing apparatus comprising:
one or more memories storing instructions; and
one or more processors that, upon execution of the instructions, operate to:
set a first region used for focus detection in a first image formed via a first optical system and a second region used for focus detection in a second image formed via a second optical system,
perform focusing by moving a lens included in at least one of the first and second optical systems,
acquire, in a case where a difference between a first defocus amount of the first region and a second defocus amount of the second region is smaller than a first threshold value, a moving amount of the lens based on at least one of the first and second defocus amounts, and
change sizes of the first and second regions in a case where the difference is greater than the first threshold value.

2. The focusing apparatus according to claim 1, wherein the one or more processors operate to change the sizes of the first and second regions in a parallax direction of the first and second optical systems, in a case where the difference is greater than the first threshold value.

3. The focusing apparatus according to claim 2, wherein in a case where the difference is greater than the first threshold value, the one or more processors operate to reduce the sizes of the first and second regions in the parallax direction.

4. The focusing apparatus according to claim 3, wherein in a case where the first and second regions are regions centered on first and second positions, respectively, and the one or more processors cannot reduce the sizes of the first and second regions in the parallax direction, the one or more processors operate to set the first and second regions to regions centered on third and fourth positions, respectively, which are located in a direction orthogonal to the parallax direction from the first and second positions.

5. The focusing apparatus according to claim 4, wherein in a case where each of a difference between a defocus amount of the first region centered on the first position and a defocus amount of the first region centered on the third position, and a difference between a defocus amount of the second region centered on the second position and a defocus amount of the second region centered on the fourth position, is smaller than a second threshold value.

6. The focusing apparatus according to claim 4, wherein a difference between a defocus amount of the first region centered on the third position and a defocus amount of the second region centered on the fourth position is smaller than a difference between a defocus amount of the first region centered on the first position and a defocus amount of the second region centered on the second position.

7. The focusing apparatus according to claim 1, wherein the one or more processors operate to change the sizes of the first and second regions in a direction orthogonal to a parallax direction of the first and second optical systems in a case where the first and second regions include pupils and the difference is greater than the first threshold value.

8. The focusing apparatus according to claim 7, wherein the one or more processors operate to increase the sizes of the first and second regions in a case where the first and second regions include pupils and the difference is greater than the first threshold value.

9. The focusing apparatus according to claim 1, wherein the one or more processors operate to:
change the size of the second region to the size of the first region in a case where a detection state of an object in the first image differs from a detection state of the object in the second image, and
change the size of the second region in a case where the difference is greater than the first threshold value after changing the size of the second region to the size of the first region.

10. The focusing apparatus according to claim 9, wherein the one or more processors operate to reduce the size of the second region in a case where the difference is greater than the first threshold value after changing the size of the second region to the size of the first region.

11. The focusing apparatus according to claim 1, wherein the one or more processors operate to:
determine an in-focus state in a case where the first and second defocus amounts are smaller than a third threshold value, and
determine an out-of-focus state in a case where the first and second defocus amounts are greater than the third threshold value.

12. The focusing apparatus according to claim 11, wherein the first threshold value is equal to or less than the third threshold value.

13. The focusing apparatus according to claim 1, wherein the one or more processors operate to change the sizes of the first and second regions in a case where the first and second defocus amounts are smaller than a fourth threshold value and the difference is greater than the first threshold value.

14. The focusing apparatus according to claim 1, wherein the one or more processors operate to cause a display apparatus to superimpose the first and second regions on the first and second images and display them as a live-view image.

15. The focusing apparatus according to claim 14, wherein in a case where the one or more processors changes the sizes of the first and second regions while the one or more processors cause the display apparatus to superimpose the first and second regions on the first and second images and display them as a live-view image, the one or more processors operate to cause the display apparatus to display the first and second regions after changing the sizes of the first and second regions.

16. The focusing apparatus according to claim 1, wherein the one or more processors operate to acquire the first and second defocus amounts and reliabilities of the first and second defocus amounts using phase differences in at least two directions obtained from the first and second regions.

17. An image pickup apparatus comprising:
a focusing apparatus; and
an image sensor,
wherein the focusing apparatus includes:
one or more memories storing instructions; and
one or more processors that, upon execution of the instructions, operate to:
set a first region used for focus detection in a first image formed via a first optical system and a second region used for focus detection in a second image formed via a second optical system,
perform focusing by moving a lens included in at least one of the first and second optical systems,
acquire, in a case where a difference between a first defocus amount of the first region and a second defocus amount of the second region is smaller than a first threshold value, a moving amount of the lens based on at least one of the first and second defocus amounts, and
change sizes of the first and second regions in a case where the difference is greater than the first threshold value.

18. A focusing method comprising:
setting a first region used for focus detection in a first image formed via a first optical system and a second region used for focus detection in a second image formed via a second optical system,
performing focusing by moving a lens included in at least one of the first and second optical systems,
acquiring, in a case where a difference between a first defocus amount of the first region and a second defocus amount of the second region is smaller than a first threshold value, a moving amount of the lens based on at least one of the first and second defocus amounts, and
changing sizes of the first and second regions in a case where the difference is greater than the first threshold value.

19. A non-transitory computer-readable storage medium storing a program that causes a computer to execute the focusing method according to claim 18.
